(19) United States
(12) Patent Application Publication
(10) Pub. No.: US 2025/0183398 A1
(43) Pub. Date: Jun. 5, 2025

(54) METHOD USING SOLVENT EXTRACTION FOR SELECTIVE RECOVERY OF VALUABLE METAL FROM LITHIUM SECONDARY BATTERY WASTE MATERIAL

(71) Applicant: INDUSTRY FOUNDATION OF CHONNAM NATIONAL UNIVERSITY, Gwangju (KR)

(72) Inventors: MYONG JUN KIM, Gwangju (KR); JEON WOONG AN, Jeollanam-do (KR); YOUN KYU YI, Jeollanam-do (KR)

(21) Appl. No.: 18/841,481

(22) PCT Filed: Apr. 6, 2022
(86) PCT No.: PCT/KR2022/004965

§ 371 Date: Aug. 26, 2024

(30) Foreign Application Priority Data
Mar. 21, 2022 (KR) 10-2022-0034455

(51) Int. Cl. H01M 10/54; C22B 1/02; C22B 3/00; C22B 7/00; C22B 26/12; C22B 47/00

(52) U.S. Cl. CPC H01M 10/54; C22B 1/02; C22B 7/007; C22B 7/008; C22B 23/043; C22B 23/0476; C22B 26/12; C22B 47/0063; C22B 47/009

(57) ABSTRACT

In a method of selectively recovering a valuable metal from lithium secondary battery waste, a complex oxide is separated from a lithium secondary battery waste powder. The powder is dissolved in sulfuric acid. The solution is separated into a solution and a residue by solid-liquid separation. The solution is subjected to solid-liquid separation to produce a solution and a solid. Valuable metal manganese is extracted from the solution by solvent extraction, and the remaining valuable metals including cobalt, nickel, and lithium are separated into a first raffinate. Valuable metal cobalt is extracted from the first raffinate by solvent extraction, and the remaining valuable metals are separated into a second raffinate. Valuable metal nickel is extracted from the second raffinate by solvent extraction, and the remaining valuable metal lithium is separated into a third raffinate. Valuable metal lithium is extracted and concentrated from the third raffinate.

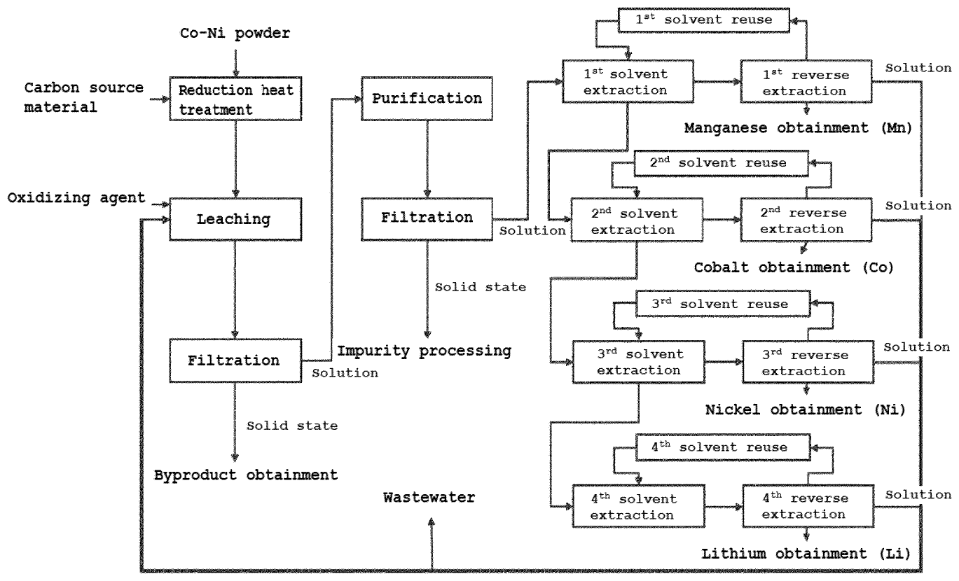

### CROSS REFERENCE TO RELATED APPLICATIONS AND CLAIM OF PRIORITY

This application claims benefit under 35 U.S.C. 119, 120, 121, or 365(c), and is a National Stage entry from International Application No. PCT/KR2022/004965 filed on Apr. 6, 2022, which claims priority to the benefit of Korean Patent Application No. 10-2022-0034455 filed on Mar. 21, 2022, in the Korean Intellectual Property Office, the entire contents of which are incorporated herein by reference.

### BACKGROUND

### 1. Technical Field

The present disclosure relates to a method of selectively recovering high-purity valuable metals from lithium secondary battery waste through solvent extraction. More specifically the present disclosure relates to a method of selectively recovering valuable metals contained in waste powder by selectively controlling impurities from waste powder through leaching, purification, and solvent extraction for recycling of waste.

In addition, when using existing lithium recovery processes, lithium cannot be recovered due to the high solubility of lithium compounds, and lithium is discarded as wastewater. When treating wastewater, wastewater is treated through evaporation or dilution, resulting in lithium loss and enormous wastewater treatment costs.

Accordingly, the present disclosure relates to a method of minimizing wastewater treatment costs and maximizing a lithium recovery rate by recovering most of the lithium through solvent extraction during lithium recovery.

### 2. Background Art

Due to a surge in raw material prices and revitalization of the electric vehicle market, the global market for recycling spent batteries of electric vehicles is expected to grow enormously.

Spent batteries of electric vehicles contain a large amount of valuable metals, such as manganese, cobalt, nickel, and lithium, which are essential for battery construction.

Assuming that the lifespan of electric vehicle batteries is 10 years, the market for recycling spent batteries will grow rapidly.

When recycling spent batteries, the metal ions may be recovered through leaching, purification, and solvent extraction by dissolving a powder obtained by shredding and pulverizing the spent batteries in sulfuric acid.

In the conventional method of recycling spent batteries, the solvent extraction process is required to be performed several times to selectively recover ions. However, there is a limitation in selectively separating impurities and valuable metals such as manganese, cobalt, nickel, and lithium.

In addition, there are other limitations. One is when using existing lithium recovery processes, lithium cannot be recovered due to the high solubility of lithium compounds, and lithium is discarded as wastewater. The other one is when treating wastewater, wastewater is treated through evaporation or dilution, resulting in lithium loss and enormous wastewater treatment costs.

### SUMMARY

An objective of the present disclosure is to provide a method of selectively recovering valuable metals from lithium secondary battery waste through solvent extraction according to an embodiment of the present disclosure. In the method, valuable metals such as high-purity manganese (Mn), cobalt (Co), nickel (Ni), and lithium (Li) may be recovered through selective recovery and removal of impurities such as iron (Fe) and aluminum (Al). The task is done by utilizing solvent extraction technology with lithium secondary battery waste powder.

Meanwhile, the objective of the present disclosure is not limited to the objective mentioned above, and other objectives not mentioned can be clearly understood by those skilled in the art from the description below.

To achieve the mentioned objective, a method of selectively recovering valuable metals from lithium secondary battery waste through solvent extraction according to an embodiment of the present disclosure may include (a) separating complex oxides by performing reduction heat treatment on a lithium secondary battery waste powder containing valuable metals present as the complex oxides, (b) dissolving the powder in sulfuric acid to produce a solution containing the valuable metals and impurities leached from the powder, (c) separating the solution produced in the step (b) into a solution and a residue by solid-liquid separation, (d) removing the impurities by adding an alkaline reagent to the solution produced in the step (c), (e) subjecting the solution from which the impurity has been removed to solid-liquid separation to produce a solution and a solid, (f) extracting valuable metal manganese from the solution produced in the step (e) by solvent extraction, and separating the remaining valuable metals including cobalt, nickel, and lithium into a first raffinate, (g) extracting valuable metal cobalt from the first raffinate produced in the step (f) by solvent extraction, and separating the remaining valuable metals including nickel and lithium into a second raffinate, (h) extracting valuable metal nickel from the second raffinate produced in the step (g) by solvent extraction, and separating the remaining valuable metal lithium into a third raffinate, and (i) extracting and concentrating valuable metal lithium from the third raffinate produced in the step (h) by solvent extraction.

Preferably, in the step (i), lithium, a valuable metal, may be recovered in the form of a lithium compound such as lithium carbonate or lithium hydroxide by using an extracted lithium sulfate solution.

Preferably, in the step (a), one or more carbon source materials selected from the group consisting of graphite, activated carbon, carbon black, and amorphous carbon may be mixed.

Preferably, the reduction heat treatment in the step (a) may be performed in an inert atmosphere to which an inert gas is added.

Preferably, in the step (b), an oxidizing agent made of air or hydrogen peroxide may be further added. The alkaline reagent in the step (d) is any one selected from the group consisting of calcium hydroxide, sodium hydroxide, and soda ash. The alkaline reagent may be added so that the solution has a pH of 3 to 7.

Preferably, in the step (d), an oxidizing agent including hydrogen peroxide and potassium sulfate may be further added.

Preferably, in the step (f), solvent extraction may be performed with a di(-2-ethylhexyl)phosphoric acid-based extractant or with a mixture of the extractant and kerosene-based diluent.

Preferably, in the solvent extraction in the step (f), the pH may be adjusted to a range of 1 to 6 by using a sulfuric acid and alkaline reagent.

Preferably, in the step (g), solvent extraction may be performed with a bis(2,4,4-trimethylpentyl)phosphinic acid-based or with a mixture of the extractant and a kerosene-based diluent.

Preferably, in the solvent extraction in the step (g), the pH may be adjusted to a range of 2 to 7 by using sulfuric acid and alkaline reagent.

Preferably, in the steps (h) and (i), respectively, solvent extraction may be performed with a phosphorus-based extractant or with a mixture of the extractant with a kerosene-based diluent.

Preferably, in the solvent extraction in the step (h), the pH may be adjusted to a range of 1 to 6 by using sulfuric acid and alkaline reagent.

Preferably, in the solvent extraction in the step (i), the pH may be adjusted to a range of 4 to 10 by using sulfuric acid and alkaline reagent.

A method of selectively recovering valuable metals from lithium secondary battery waste through solvent extraction according to embodiments of the present disclosure is excellent in being capable of selectively recovering valuable metals such as high-purity manganese (Mn), cobalt (Co), nickel (Ni), and lithium (Li) through selective recovery and removal of impurities such as iron (Fe) and aluminum (Al) by utilizing solvent extraction technology with a lithium secondary battery waste powder.

### BRIEF DESCRIPTION OF THE DRAWING

FIGURE is an overall process diagram of a method of selectively recovering high-purity valuable metals from lithium secondary battery waste through solvent extraction according to an embodiment of the present disclosure.

### DETAILED DESCRIPTION

The best mode for carrying out the present disclosure includes (a) separating complex oxides by performing reduction heat treatment on a lithium secondary battery waste powder containing valuable metals present as the complex oxides, (b) dissolving the powder in sulfuric acid to produce a solution containing the valuable metals and impurities leached from the powder, (c) separating the solution produced in the step (b) into a solution and residue by solid-liquid separation, (d) removing the impurities by adding an alkaline reagent to the solution produced in the step (c), (e) subjecting the solution from which the impurity has been removed to solid-liquid separation to produce a solution and a solid, (f) extracting valuable metal manganese from the solution produced in the step (e) by solvent extraction, and separating the remaining valuable metals including cobalt, nickel, and lithium into a first raffinate, (g) extracting valuable metal cobalt from the first raffinate produced in the step (f) by solvent extraction, and separating the remaining valuable metals including nickel and lithium into a second raffinate, (h) extracting valuable metal nickel from the second raffinate produced in the step (g) by solvent extraction, and separating the remaining valuable metal lithium into a third raffinate, and (i) extracting and concentrating valuable metal lithium from the third raffinate produced in the step (h) by solvent extraction.

At this time, in the step (i), lithium, a valuable metal, is recovered in the form of a lithium compound such as lithium carbonate or lithium hydroxide by using an extracted lithium sulfate solution.

The terms used in the present disclosure are general terms that are currently widely used as much as possible. However, in certain cases, there are terms arbitrarily selected by the applicants, and in this case, the meanings of the terms are required to be understood by considering the meaning described or used in the specific content for carrying out the disclosure, rather than simply the names of the terms.

Hereinafter, the technical configuration of the present disclosure will be described in detail with reference to the preferred examples shown in the attached drawings.

In this regard, first, referring to FIGURE, which is an overall process diagram of a method of selectively recovering high-purity valuable metals from lithium secondary battery waste through solvent extraction according to an embodiment of the present disclosure, the present disclosure involves (a) separating complex oxides by performing reduction heat treatment on a lithium secondary battery waste powder containing valuable metals present as the complex oxides.

At this time, in performing the reduction heat treatment of a waste powder in the step (a), carbon source materials may be further mixed, if necessary, depending on the properties of the powder. The carbon source materials may be added not to exceed twice the molar ratio of the complex oxides.

At this time, the carbon source materials according to another embodiment of the present disclosure may use any one or more carbon source materials selected from the group consisting of graphite, activated carbon, carbon black, and amorphous carbon. When performing reduction heat treatment by mixing the powder and carbon source materials, the reduction heat treatment may be performed in an inert atmosphere by adding inert gases containing nitrogen and argon to the atmosphere.

More specifically, the reduction heat treatment according to yet another embodiment of the present disclosure may be performed in an inert atmosphere for 1 to 5 hours, more preferably 1 to 4 hours, and the reaction temperature may be in a range of 600° C. to 1,200° C., more preferably 600° C. to 1,000° C.

Likewise, when heat treatment is performed in an inert atmosphere in the reduction heat treatment, the complex oxides may be decomposed and recovered, and the reaction equations for this are as follows.

CoₐLi_{b}Mn_{c}NiaO_{2(a+b+c+a)}+(a+b+c+d)C→aCoO+bLi₂O+cMnO+dNiO+(a+b+c+d)CO(g) [Reaction equation 1]

Me(Mn,Co,Ni)O+C→Me(Mn,Ni,Co)+CO(g),

2CO+O₂→2CO₂ [Reaction equation 2]

2LiO+C→Li₂O+CO(g),

2CO+O₂→2CO₂,

Li₂O+CO₂→Li₂CO₃ [Reaction equation 3]

Meanwhile, in the step (a), samples in which the complex oxides are completely separated into individual metal oxides may be recovered by reactions based on the reaction equations.

That is, the reactions in the step (a) are performed to easily leach valuable metals to be recovered, such as manganese, cobalt, nickel, and lithium. At this time, in yet another embodiment of the present disclosure, the metals in the step (a) include the to-be-recovered valuable metals (for example, manganese, cobalt, nickel, and lithium), impurity metals (for example, iron and aluminum), and carbon.

Still, the mentioned metals are not necessarily limited thereto. The metals may include various metals (including valuable metals) contained in the positive electrode materials or negative electrode materials used in secondary batteries. Furthermore, the content of the valuable metals contained in the lithium secondary battery waste powder may vary depending on the constituents of the waste, so there is no special limitation thereon.

Meanwhile, the method of selectively recovering valuable metals from lithium secondary battery waste through solvent extraction according to yet another embodiment of the present disclosure involves (b) dissolving the powder in sulfuric acid to produce a solution containing the valuable metals and impurities leached from the powder.

At this time, in the step (b), sulfuric acid is added while stirring the powder and water. Herein, the sulfuric acid may be added by calculating an ion equivalent ratio of the ions to be leached. When adding sulfuric acid, it is possible to add sulfuric acid in an amount ranging from 1 to 10 times the ion equivalent ratio of the ions to be dissolved, preferably from 1 to 5 times the ion equivalent ratio.

Meanwhile, in yet another embodiment of the present disclosure, air may be further added in the step (b) to improve the leaching efficiency of valuable metals and shorten the reaction time. At this time, the amount of air added may be added in a fixed amount selected depending on the change in oxidation-reduction potential value based on the powder composition, so there is no special limitation on the amount of air.

In this process, the leaching time may be shortened by adding additional samples that act as oxidizing agents, such as hydrogen peroxide. Since the type and amount of oxidizing agents may vary depending on the degree of time reduction, there is no special limitation on the amount of the oxidizing agents.

Meanwhile, after adding the sulfuric acid, the reaction proceeds for 1 to 24 hours, more preferably 1 to 12 hours. Likewise, when sulfuric acid is added and reacted like this, manganese sulfate, cobalt sulfate, nickel sulfate, and lithium sulfate may be recovered, and the reaction equation for this is as follows.

Me(Mn,Co,Ni,Li)O+H₂SO₄→MeSO₄(aq)+H₂O [Reaction equation 4]

Meanwhile, in yet another embodiment of the present disclosure, the dissolving of the powder in the step (b) may be performed at a reaction temperature in a range of 40° C. to 90° C., more preferably 50° C. to 80° C., to improve the leaching efficiency of valuable metals.

Meanwhile, the method of selectively recovering valuable metals from lithium secondary battery waste through solvent extraction according to yet another embodiment of the present disclosure involves (c) separating the solution produced in the step (b) into a solution and residue by solid-liquid separation.

At this time, in the step (c), a solid is separated from the solution recovered according to the mentioned reaction equation by solid-liquid separation, and a liquid containing the valuable metals is recovered. Herein, the separated solid may be reprocessed and recovered as a by-product (carbon) of the process.

Meanwhile, the solution recovered by the solid-liquid separation in the step (c) is a solution in which the valuable metals to be recovered, such as manganese, cobalt, nickel, and lithium, have leached. At this time, there are impurities, such as iron and aluminum other than the to-be-recovered valuable metals such as manganese, cobalt, nickel, and lithium in the solution recovered in the step (c). Thus, it is not possible to selectively recover valuable metals.

Meanwhile, the method of selectively recovering valuable metals from lithium secondary battery waste through solvent extraction according to yet another embodiment of the present disclosure involves (d) removing the impurities by adding an alkaline reagent to the solution produced in the step (c).

At this time, the alkaline reagent in the step (d) is any one selected from the group consisting of calcium hydroxide, sodium hydroxide, and soda ash. The alkaline reagent is added so that the solution has a pH of 3 to 7, more preferably 4 to 6.

Meanwhile, the impurities removed in the step (d) are iron and aluminum. To be more specific about this, after adding the alkaline reagent, the reactions proceed for 10 to 240 minutes, more preferably 100 to 120 minutes.

At this time, by adjusting the pH as described above, iron is removed in the form of 2Fe(OH)3 and Fe2(SO4)3, and aluminum is removed in the form of 2Al(OH)3. The specific reaction equations for these are as follows.

Al₂(SO₄)₃(aq)+3H₂O→2Al(OH)₃(s)+3H₂SO₄ [Reaction equation 5]

Fe₂(SO₄)₃(aq)+3H₂O→2Fe(OH)₃(s)+3H₂SO₄ [Reaction equation 6]

2FeSO₄(aq)+½O₂+H₂SO₄→Fe₂(SO₄)₃(s)+H₂O [Reaction equation 7]

Meanwhile, according to yet another embodiment of the present disclosure, to solve the difficulty of solid-liquid separation when some impurities are removed in the step (d), potassium sulfate may be added to precipitate the impurities together with iron as a compound in the form of jarosite. Hydrogen peroxide (H₂O₂) may be added to increase iron and aluminum removal efficiency. A detailed reaction occurs according to the following reaction equation, and the difficulty of solid-liquid separation may be solved.

3Fe₂(SO₄)₃+K₂SO₄+12H₂O→2KFe₃(SO₄)₂(OH)₆+6H₂SO₄ [Reaction equation 8]

Meanwhile, according to yet another embodiment, after the removal of the impurities in the step (d), step (e) is performed to have the solution from which the impurity has been removed subjected to solid-liquid separation to produce a solution and a solid. Through the step (e), a solid in the solution may be separated, and a liquid in the solution may be recovered. At this time, the solution recovered by solid-liquid separation in the step (e) is a solution from which the impurities such as iron and aluminum are removed, and the solution contains valuable metals to be recovered.

Meanwhile, according to yet another embodiment, the method of selectively recovering valuable metals from lithium secondary battery waste through solvent extraction involves (f) extracting valuable metal manganese from the solution produced in the step (e) by solvent extraction, and separating the remaining valuable metals including cobalt, nickel, and lithium into a first raffinate.

At this time, to be more specific about the step (f), in solvent extraction in step (f), a di(2-ethylhexyl)phosphoric acid-based extractant may be used, or the di(2-ethylhexyl)phosphoric acid-based extractant and kerosene-based diluent may be mixed and used. The concentration of the extractant used in the step (f) may be adjusted depending on the manganese content of the solution recovered in the step (e).

In addition, to increase the selective separation of manganese, before extraction, a solvent may be reacted with an aqueous cobalt sulfate solution to extract cobalt, and a solvent containing cobalt may be used during extraction. For the convenience of the process, the concentration of valuable metals may be adjusted by adding distilled water.

At this time, to improve the efficiency of solvent extraction, the pH is adjusted to fall within a range of 1 to 6, more preferably 2 to 5, by using a sulfuric acid and alkaline reagent. Through this, manganese may be extracted, and cobalt, nickel, and lithium may be recovered into a first raffinate.

Meanwhile, the valuable metal extraction reactions in the step (f) are carried out according to the following reaction equations. Manganese may be selectively recovered, and cobalt, nickel, and lithium may be recovered into the first raffinate.

MnSO₄(aq)+R—H₂(Org)→R—Mn(org)+H₂SO₄ [Reaction equation 9, extraction]

R—Co(org)+MnSO₄→R—Mn(Org)+CoSO₄ [Reaction equation 10, washing]

R—Mn(org)+H₂SO₄→R—H₂(Org)+MnSO₄ [Reaction equation 11, reverse extraction]

Meanwhile, according to yet another embodiment, the method of selectively recovering valuable metals from lithium secondary battery waste through solvent extraction involves (g) extracting valuable metal cobalt from the first raffinate produced in the step (f) by solvent extraction, and separating the remaining valuable metals including nickel and lithium into a second raffinate.

At this time, in solvent extraction in the step (g), a bis(2,4,4-trimethylpentyl)phosphinic acid-based extractant may be used, or the bis(2,4,4-trimethylpentyl)phosphinic acid-based extractant and kerosene-based diluent may be mixed and used. The concentration of the extractant used in the step (g) may be adjusted depending on the cobalt content of the solution recovered in the step (f).

Meanwhile, to improve the efficiency of solvent extraction, the pH is adjusted to fall within a range of 2 to 7, more preferably 3 to 6, by using a sulfuric acid and alkaline reagent. Through this, cobalt may be extracted, and nickel and lithium may be recovered into the second raffinate.

Meanwhile, the valuable metal extraction reactions in the step (g) are carried out according to the following reaction equations. Cobalt may be selectively recovered, and nickel and lithium may be recovered into the second raffinate.

CoSO₄(aq)+R—H₂(Org)→R—Co(org)+H₂SO₄ [Reaction equation 12, extraction]

R—Ni(org)+CoSO₄→R—Co(Org)+NiSO₄ [Reaction equation 13, washing]

R—Co(org)+H₂SO₄→R—H₂(Org)+CoSO₄ [Reaction equation 14, reverse extraction]

Meanwhile, according to yet another embodiment, the method of selectively recovering valuable metals from lithium secondary battery waste through solvent extraction involves (h) extracting valuable metal nickel from the second raffinate produced in the step (g) by solvent extraction, and separating the remaining valuable metal lithium into a third raffinate.

At this time, in solvent extraction in the step (h), a phosphorus-based extractant may be used, or the phosphorus-based extractant and the kerosene-based diluent may be mixed and used. The concentration of the extractant used in the step (h) may be adjusted depending on the nickel content of the solution recovered in the step (g).

Meanwhile, to improve the efficiency of solvent extraction, the pH is adjusted to fall within a range of 1 to 6, more preferably 2 to 5, using sulfuric acid and alkaline reagent. Through this, nickel may be extracted, and lithium may be recovered into the third raffinate.

Meanwhile, the valuable metal extraction reactions in the step (h) are carried out according to the following reaction equations. Nickel may be selectively recovered, and lithium may be recovered into the third raffinate.

NiSO₄(aq)+R—H₂(Org)→R—Ni(org)+H₂SO₄ [Reaction equation 15, extraction]

R—Li(org)+H₂SO₄→R—H₂(Org)+Li₂SO [Reaction equation 16, washing]

R—Ni(org)+H₂SO₄→R—H₂(Org)+NiSO₄ [Reaction equation 17, reverse extraction]

Meanwhile, according to yet another embodiment, the method of selectively recovering valuable metals from lithium secondary battery waste through solvent extraction involves (i) extracting and concentrating the valuable metal lithium from the third raffinate produced in the step (h) by solvent extraction.

At this time, in solvent extraction in the step (i), a phosphorus-based extractant may be used, or the phosphorus-based extractant and a kerosene-based diluent may be mixed and used. The concentration of the extractant used in the step (i) may be adjusted depending on the lithium content of the solution recovered in the step (h).

At this time, to improve the efficiency of solvent extraction, the pH is adjusted to fall within a range of 4 to 10, more preferably 5 to 9, using sulfuric acid and alkaline reagent. Through this, lithium may be extracted and concentrated.

Meanwhile, the valuable metal extraction reactions in the step (i) are carried out according to the following reaction equations, and nickel may be selectively recovered, and lithium may be recovered into an aqueous solution.

Li₂SO₄(aq)+2R—H(Org)→2R—Li(org)+H₂SO₄ [Reaction equation 18, extraction]

2R—Li(org)+H₂SO₄→2R—H₂(Org)+Li₂SO₄ [Reaction equation 19, reverse extraction]

Through this, unlike commercially applied lithium recovery methods, most lithium may be recovered through solvent extraction.

Meanwhile, in the step (i), lithium carbonate or lithium hydroxide may be recovered by using an extracted lithium sulfate solution.

Hereinafter, specific experimental examples according to embodiments of the present disclosure will be described in detail.

### Experimental Example 1. Reduction Heat Treatment for Lithium Secondary Battery Source Material Waste

Based on the mole ratio of valuable metals in the lithium secondary battery waste, carbon black as carbon source materials was charged into an electric furnace at a 1:1 mole ratio and was subjected to reduction heat treatment at a temperature of 600° C. for 3 hours in a nitrogen atmosphere.

The analysis results of the source material waste sample (Table 1) and after reduction heat treatment (Table 2) are as shown below.

TABLE 1

| Element | Co | Ni | Mn | Li | Al | Cu | Zn | Na | C |
|---|---|---|---|---|---|---|---|---|---|
| % | 6.1 | 26.4 | 7.6 | 4.5 | 1.0 | <1 | <1 | <1 | 35 |

TABLE 2

| Element | Co | Ni | Mn | Li | Al | Cu | Zn | Na | C |
|---|---|---|---|---|---|---|---|---|---|
| % | 6.4 | 27.6 | 7.9 | 5.4 | 1.1 | <1 | <1 | <1 | 33 |

### Experimental Example 2. Valuable Metal Leaching after Reduction Heat Treatment

After reduction heat treatment at a solid-liquid concentration of 10%, 120 g of product and 1,080 g of DIW were prepared.

A concentrated sulfuric acid was used to maintain pH at 1 as a leaching condition. Air was simultaneously introduced to adjust an oxidation-reduction potential value.

A reaction temperature was adjusted to 60° C. to 70° C. using a heating mantle. The oxidation-reduction potential value was adjusted to 400 mV, and a reaction was performed for 8 hours.

The analysis results of the leached residue after the reaction are shown in Table 3 below. As a result, more than 99% of the valuable metals to be recovered, such as cobalt, nickel, manganese, and lithium, were leached into a solution.

TABLE 3

| Element | Co | Ni | Mn | Li | Al | Cu | Zn | Na | C |
|---|---|---|---|---|---|---|---|---|---|
| % | <0.01 | <0.01 | <0.01 | <0.01 | <0.01 | <0.01 | <0.01 | <0.01 | 99> |

The leach slurry was subjected to a solid-liquid separation, and then the residue was discarded. The valuable metal leachate was recovered. The analysis results are shown in Table 4 below.

TABLE 4

| Element | Co | Ni | Mn | Li | Al | Cu | Zn | Na | Fe |
|---|---|---|---|---|---|---|---|---|---|
| ppm | 6,656 | 22,726 | 8,006 | 4,532 | 911 | 234 | 89 | 22 | <5 |

### Experimental Example 3. Manganese Solvent Extraction after Removing Impurities

The recovered solution contained valuable metals such as manganese, cobalt, nickel, and lithium, and it was difficult to selectively recover the valuable metals as products.

Therefore, a synthetic solution was prepared to selectively separate manganese, a valuable metal, and the components of the synthetic solution are shown in Table 5 below.

TABLE 5
(Unit: ppm)
Element

| Mn | Co | Ni | Li |
|---|---|---|---|
| 1,573 | 1,443 | 4,433 | 1,594 |

In the solvent extraction of the valuable metal, a solvent containing a kerosene-based diluent and a di(2-ethylhexyl)phosphoric acid-based extractant mixed in a volume ratio of 75:25 was used.

The solvent extraction was performed by mixing the solvent and the solution in a volume ratio (O:A Ratio) of 1:1. During the extraction, the pH was adjusted to 2 to 5 with a 1 M solution of caustic soda, which was a neutralizing agent.

Before the solvent extraction, a solvent mixed with a diluent and an extractant was reacted with a cobalt sulfate solution to extract cobalt and get the cobalt to move into the solvent, thereby performing solvent extraction.

After the solvent extraction reaction of the valuable metal, an organic phase and aqueous phase were separated through a separatory funnel. After the solvent extraction, the amount extracted into the solvent was reversely calculated through an aqueous phase (raffinate) analysis.

At this time, the composition of a raffinate is shown in Table 6 below.

TABLE 6
(Unit: ppm)
Element

| Mn | Co | Ni | Li |
|---|---|---|---|
| 34 | 3,202 | 3,661 | 1,386 |

As shown in the analysis results, in the manganese solvent extraction, most of the manganese was extracted from the solvent, but some of the nickel and lithium to be separated were extracted.

To separate the partially extracted nickel and lithium, a washing was performed. A reverse extraction was performed to recover manganese in an aqueous phase. The composition of the reverse extract is shown in Table 7 below.

TABLE 7
(Unit: ppm)
Element

| Mn | Co | Ni | Li |
|---|---|---|---|
| 3,522 | 28 | 9 | <5 |

### Experimental Example 4. Solvent Extraction of Cobalt from Manganese Solvent Extraction Raffinate

After selectively separating the manganese, the solvent-extracted raffinate contained valuable metals such as cobalt, nickel, and lithium to be recovered.

To selectively separate cobalt from the raffinate, the manganese solvent-extracted raffinate was used. The composition of valuable metals in the raffinate is shown in Table 8.

TABLE 8
(Unit: ppm)
Element

| Mn | Co | Ni | Li |
|---|---|---|---|
| 34 | 3,202 | 3,661 | 1,386 |

In the solvent extraction of the valuable metal, a solvent containing a kerosene-based diluent and a bis(2,4,4-trimethylpentyl)phosphinic acid series extractant mixed in a volume ratio of 95:5 was used.

The solvent extraction was performed by mixing the solvent and the solution in a volume ratio (O:A Ratio) of 1:1. During the extraction, the pH was adjusted to 4 to 7 with a 1 M solution of caustic soda, which was a neutralizing agent.

After the solvent extraction reaction of the valuable metal, an organic phase and aqueous phase were separated through a separatory funnel. After the solvent extraction, the amount extracted into the solvent was reversely calculated through an aqueous phase (raffinate) analysis.

At this time, the composition of a raffinate is as shown in Table 9 below.

TABLE 9
(Unit: ppm)
Element

| Mn | Co | Ni | Li |
|---|---|---|---|
| <5 | 150 | 3,123 | 1,392 |

As shown in the analysis results, in the cobalt solvent extraction, most of the cobalt was extracted from the solvent, but some of the nickel to be separated was extracted.

To separate the partially extracted nickel, a washing was performed. A reverse extraction was performed to recover cobalt in an aqueous phase. The composition of the reverse extract is shown in Table 10 below.

TABLE 10
(Unit: ppm)
Element

| Mn | Co | Ni | Li |
|---|---|---|---|
| 12 | 1,833 | 36 | <5 |

### Experimental Example 5. Solvent Extraction of Nickel from Cobalt Solvent Extraction Raffinate

After selectively separating the manganese and cobalt, the solvent-extracted raffinate contained valuable metals such as nickel and lithium to be recovered.

To selectively separate nickel from the raffinate, a synthetic solution was prepared and used. The valuable metal composition of the synthetic solution is shown in Table 11 below.

TABLE 11
(Unit: ppm)
Element

| Ni | Li |
|---|---|
| 2,634 | 1,426 |

In the solvent extraction of the valuable metal, a solvent containing a kerosene-based diluent and a phosphorus-based extractant mixed in a volume ratio of 60:40 was used.

The solvent extraction was performed by mixing the solvent and the solution in a volume ratio (O:A Ratio) of 1:1. During the extraction, the pH was adjusted to 2 to 5 with a 1 M solution of caustic soda, which was a neutralizing agent.

After the solvent extraction reaction of the valuable metal, an organic phase and aqueous phase were separated through a separatory funnel. After the solvent extraction, the amount extracted into the solvent was reversely calculated through an aqueous phase (raffinate) analysis.

At this time, the composition of a raffinate is shown in Table 12 below.

TABLE 12
(Unit: ppm)
Element

| Ni | Li |
|---|---|
| <5 | 1,263 |

As shown in the analysis results, in the nickel solvent extraction, most of the nickel was extracted from the solvent, but some of the lithium to be separated was extracted.

To separate the partially extracted lithium, a washing was performed. A reverse extraction was performed to recover lithium in an aqueous phase. The composition of the reverse extract is shown in Table 13 below.

TABLE 13
(Unit: ppm)
Element

| Ni | Li |
|---|---|
| 2,405 | <5 |

### Experimental Example 6. Solvent Extraction of Lithium from Nickel Solvent Extraction Raffinate

After selectively separating the manganese, cobalt, and nickel, the solvent-extracted raffinate contained a valuable lithium metal to be recovered.

To selectively separate lithium from the raffinate, the raffinate was prepared after solvent extraction of nickel. The valuable metal composition of the solution is shown in Table 14 below.

TABLE 14
(Unit: ppm)
Element

| Ni | Li |
|---|---|
| 10 | 972 |

In the solvent extraction of the valuable metal, a solvent containing a kerosene-based diluent and a phosphorus-based extractant mixed in a volume ratio of 60:40 was used.

The solvent extraction was performed by mixing the solvent and the solution in a volume ratio (O:A Ratio) of 1:1. During the extraction, the pH was adjusted to 5 to 9 with a 1 M solution of caustic soda, which was a neutralizing agent.

After the solvent extraction reaction of the valuable metal, an organic phase and aqueous phase were separated through a separatory funnel. After the solvent extraction, the amount extracted into the solvent was reversely calculated through an aqueous phase (raffinate) analysis.

At this time, the composition of a raffinate is shown in Table 15 below.

TABLE 15
(Unit: ppm)
Element

| Ni | Li |
|---|---|
| N.D | 95 |

As shown in the analysis results, most of the lithium was extracted from the solvent in the lithium solvent extraction. A reverse extraction was performed to recover the lithium in an aqueous phase. The composition of the reverse extract is shown in Table 16 below.

TABLE 16
(Unit: ppm)
Element

| Ni | Li |
|---|---|
| 12 | 945 |

Consequently, a method of selectively recovering valuable metals from lithium secondary battery waste through solvent extraction according to the examples of the present disclosure is excellent, through the above-mentioned technical configurations, in being capable of selectively recovering valuable metals such as high-purity manganese (Mn), cobalt (Co), nickel (Ni), and lithium (Li) through selective recovery and removal of impurities such as iron (Fe) and aluminum (Al) by utilizing solvent extraction technology with lithium secondary battery waste powder.

As discussed above, the present disclosure has been illustrated and described with reference to preferred examples but is not limited to the above-described examples. Various changes and modifications may be made by those skilled in the art without departing from the spirit of the present disclosure.

method of selectively recovering valuable metals from lithium secondary battery waste through solvent extraction according to the embodiments of the present disclosure is excellent in being capable of selectively recovering valuable metals such as high-purity manganese (Mn), cobalt (Co), nickel (Ni), and lithium (Li) through selective recovery and removal of impurities such as iron (Fe) and aluminum (Al) by utilizing solvent extraction technology with lithium secondary battery waste powder. Thus, the method has industrial applicability.

1: A method of selectively recovering a valuable metal from lithium secondary battery waste, the method comprising:
(a) separating a complex oxide by performing reduction heat treatment on a lithium secondary battery waste powder containing the valuable metal present as the complex oxide;
(b) dissolving the powder in sulfuric acid to produce a solution containing the valuable metal and an impurity leached from the powder;
(c) separating the solution produced in the step (b) into a solution and a residue by solid-liquid separation;
(d) removing the impurity by adding an alkaline reagent to the solution produced in the step (c);
(e) subjecting the solution from which the impurity has been removed to solid-liquid separation to produce a solution and a solid;
(f) extracting valuable metal manganese from the solution produced in the step (e) by solvent extraction, and separating the remaining valuable metals including cobalt, nickel, and lithium into a first raffinate;
(g) extracting valuable metal cobalt from the first raffinate produced in the step (f) by solvent extraction, and separating the remaining valuable metals including nickel and lithium into a second raffinate;
(h) extracting valuable metal nickel from the second raffinate produced in the step (g) by solvent extraction, and separating the remaining valuable metal lithium into further a third raffinate; and
(i) extracting and concentrating valuable metal lithium from the third raffinate produced in the step (h) by solvent extraction,
wherein in the step (i), lithium, a valuable metal, is recovered in the form of a lithium compound such as lithium carbonate or lithium hydroxide by using an extracted lithium sulfate solution.

2: The method of claim 1, wherein in the step (a), one or more carbon source materials selected from the group consisting of graphite, activated carbon, carbon black, and amorphous carbon are mixed.

3: The method of claim 2, wherein the reduction heat treatment in the step (a) is heat treatment performed in an inert atmosphere to which an inert gas is added.

4: The method of claim 1, wherein in the step (b), an oxidizing agent made of air or hydrogen peroxide is further added.

5: The method of claim 1, wherein the alkaline reagent in the step (d) is any one selected from the group consisting of calcium hydroxide, sodium hydroxide, and soda ash, and
the alkaline reagent is added so that the solution has a pH of 3 to 7.

6: The method of claim 5, wherein in the step (d), an oxidizing agent including hydrogen peroxide and potassium sulfate is further added.

7: The method of claim 1, wherein the solvent extraction is performed with a di(-2-ethylhexyl)phosphoric acid-based extractant or with a mixture of a di(-2-ethylhexyl)phosphoric acid-based extractant and kerosene-based diluent.

8: The method of claim 7, wherein in the solvent extraction in the step (f), the pH is adjusted to fall within a range of 1 to 6 by using a sulfuric acid and an alkaline reagent.

9: The method of claim 1, wherein the solvent extraction in the step (g) is performed with a bis(2,4,4-trimethylpentyl) phosphinic acid-based extractant or with a mixture of the extractant and a kerosene-based diluent.

10: The method of claim 9, wherein in the solvent extraction in the step (g), the pH is adjusted to fall within a range of 2 to 7 by using a sulfuric acid and an alkaline reagent.

11: The method of claim 1, wherein the solvent extraction in the steps (h) and (i) is performed with a phosphorus-based extractant or with a mixture of the extractant and a kerosene-based diluent.

12: The method of claim 11, wherein in the solvent extraction in the step (h), the pH is adjusted to fall within a range of 1 to 6 by using a sulfuric acid and an alkaline reagent.

13: The method of claim 11, wherein in the solvent extraction in the step (i), the pH is adjusted to fall within a range of 4 to 10 by using a sulfuric acid and an alkaline reagent.
